(19) United States
(12) Patent Application Publication
(10) Pub. No.: US 2007/0103047 A1
(43) Pub. Date: May 10, 2007

(54) Fuse light for a light string

(76) Inventor: James W. Gibboney, Conyers, GA (US)

Correspondence Address: NEXSEN PRUET ADAMS KLEEMEIER, LLC, PO DRAWER 2426, COLUMBIA, SC, 29202-2426, US

(21) Appl. No.: 11/269,994

(22) Filed: Nov. 9, 2005

(51) Int. Cl. H01K 1/18

(52) U.S. Cl. 313/271

(57) ABSTRACT

A light for use in light strings has a third terminal in addition to the first and second terminals. A filament is connected between the first and second terminals; a fuse is connected between the second and third terminals; and a shunt connects the first and third terminals. If the filament burns out from long use, the shunt passes current to the fuse, which continues to protect the light, and other lights in series with it from over-current conditions.

### CROSS REFERENCE TO RELATED PATENTS

Not applicable

### BACKGROUND OF THE INVENTION

The present invention relates to strings of lights and to safety features in strings of lights in particular.

Lights strings such as the type used to decorate Christmas trees includes sets of miniature lights arranged electrically in series. In order to avoid the problem of having the whole string go out when any one light burns out, many manufacturers include shunts in the bulbs or in the sockets. However, if a bulb burns out, the current flowing though the remaining bulbs can increase, sometimes to levels unacceptable from a safety standpoint. Typically, manufacturers will install fuses in a housing in line with the lights of the string or in the plug of the light set to prevent an over-current condition from occurring. Other manufacturers will simply not provide a shunt for one of the bulbs but rather allow that bulb to burn out and thus open the circuit when the current exceeds a pre-determined level as a form of fuse. However, this type of bulb, a so-called fuse bulb but in reality just a bulb without a shunt, will burn out eventually regardless of whether any other lights have failed in the interim, leaving the whole set to fail.

There remains a need for a better way to provide a light string that will operate following the failure of any individual bulb but still protect against over-current conditions.

### SUMMARY OF THE INVENTION

According to its major aspects and briefly recited, the present invention is a fuse light for use in in a string of lights in which the lights of the string are connected electrically in series. The present fuse light acts as a fuse in the event the current in the string of lights exceeds a pre-determined level, a so-called “over-current” condition. When inserted into a light socket of the string of lights and the light string is plugged into a source of electrical power, the present fuse light lights up in the same manner as a conventional light. If the filament of the present light burns out, a shunt inside the light switches the electrical current from the filament to a fuse that acts to limit current that would otherwise exceeds the pre-determined level. The filament has failed so the light is dark, but the remaining lights of the light string continue to glow.

An important feature of the present invention is the use of a shunt as an electrical bypass circuit for maintaining the current in the other lights of a light string flowing when the filament of the present light burns out. When the filament of the present fuse light burns out, the potential for an over-current condition to occur is greater than before. Yet, as long as the current is below a pre-selected level, say, for example, when the fuse light filament is the only filament in the light string that has burned out, the balance of the light string can continue to function.

Another feature of the present invention is that the filament of the present light does not limit electrical current, unlike filaments of prior art fuse lights. Rather a fuse limits current in a light that is otherwise a regular light. Therefore the present light string is unlikely to be subjected to an over-current condition.

These and other features and their advantages will be apparent to those skilled in the art of light string design from a careful reading of the Detailed Description of Preferred Embodiments accompanied by the following drawings.

### BRIEF DESCRIPTION OF THE SEVERAL VIEWS OF THE DRAWINGS

In the drawings,

FIG. 1 is a cross sectional side view of a light according to a preferred embodiment of the present invention; and

FIG. 2 is a cross sectional side view of the light of FIG. 1 with the filament burned out.

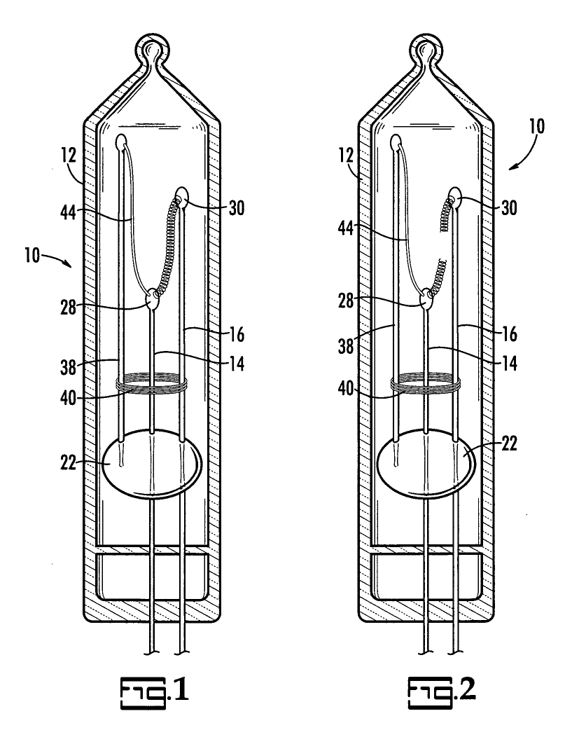

### DETAILED DESCRIPTION OF THE INVENTION

The present invention is a fuse light for use in a light string.

Referring now to the figures, there is shown a cross sectional view of a light according to a preferred embodiment of the present invention. Generally referred to using the reference number 10, light 10 has a bulb 12, typically made of glass or plastic, with a first terminal 14 and a second terminal 16 extending into bulb 12 from outside. First and second terminals 14, 16, which are both made of an electrically conductive material such as metal, are connected to a light base (not shown) that holds the terminals in spaced relation and in relatively fixed positions so that they may be placed in contact with electrical conductors. The present light is made to be used with a light base and a socket that connect terminals 14, 16 to electrical current carrying wires and are both typical of prior art miniature holiday light bases and sockets used in decorative light strings. These standard lights and light strings meet industry standards such as Underwriter's Laboratory standard 588, which is incorporated herein by reference.

First and second terminals 14, 16, pass through an insulating glass bead 22, which is also typically made of glass or plastic but which may be made of any electrically insulating material. Bead 22 spaces first and second terminals 14, 16, apart from each other and from the interior surface of bulb 12. A filament 26 is connected to the distal ends 28, 30, of first and second terminals 14, 16, respectively, through which electrical current can pass from first terminal 14 to second terminal 16, thus completing the electrical circuit. Filament 26 incandesces when electrical current passes through it, thus producing light.

There is a third terminal 38 provided in bulb 12 of light 10. Third terminal 38 does not extend outside bulb 12 but is anchored in bead 22. A shunt 40 is applied between first and third terminals 14, 38, near bead 22, either just above it or just below it. Shunt 40 is typically a coil of fine wire wrapped around first and third terminals 14, 38. Ordinarily, shunt 40 does not pass current, but, when filament 26 burns out, as shown in FIG. 2, first and third terminals 14, 38, heat up quickly, burning off the thin oxide layer on shunt 40 where shunt 40 contacts first and third terminals 14, 38, and quickly welding shunt to terminals 14, 38, thus allowing current to flow from one to the other. At that point, shunt 40 will conduct electricity from first terminal 14 to third terminal 38 and thence through a fuse 44 to second terminal 16, thus completing a new circuit that by passes filament 26. In the event of an over-current condition, fuse 44 will burn out, leaving light 10 to fail but preventing current from flowing to lights in series with light 10.

Filament 26 of light 10 may be designed to last longer than ordinary filaments. Nonetheless, filament 26 may fail from the electrical current in the light string exceeding the pre-selected value or merely from long use. In the case where filament 26 fails from excessive current, shunt 40 will pass the excessive current to fuse 44, which will also burn out immediately, thus protecting the light string from the excessive current. If however, filament 26 merely fails from long use, fuse 44 will allow the balance of the lights in the light string to operate although light 10 itself will be dark.

It is intended that the scope of the present invention include all modifications that incorporate its principal design features, and that the scope and limitations of the present invention are to be determined by the scope of the appended claims and there equivalents. It also should be understood, therefore, that the inventive concepts herein described are interchangeable and/or they can be used together in still other permutations of the present invention, and that other modifications and substitutions will be to those skilled in the art from the foregoing description of the preferred embodiments without departing from the spirit or scope of the present invention.

What is claimed is:

1. A light for use in light strings, said light comprising:
a bulb;
a first terminal extending into said bulb from outside said bulb;
a second terminal extending into said bulb from outside said bulb;
a third terminal in said bulb;
a filament electrically connecting said first terminal to said second terminal;
a fuse electrically connecting said second terminal to said third terminal; and
a shunt connected between said first terminal and said third terminal.

2. The light as recited in claim 1, further comprising a bead, said first, second and third terminals being anchored in said bead.

3. The lights as recited in claim 1, wherein said shunt is a coil of wire wrapped around said first and third terminals.

4. The light as recited in claim 1, wherein said bulb is made of glass.

5. The light as recited in claim 2, wherein said bead is made of glass.

6. The light as recited in claim 1, wherein said shunt is an electrical conductor.

7. The light as recited in claim 6, wherein said shunt has an oxide layer over said electrical conductor.

8. A light for use with a string of lights, said light comprising:
a bulb;
a first terminal extending into said bulb from outside said bulb;
a second terminal extending into said bulb from outside said bulb;
a filament electrically connecting said first terminal to said second terminal;
a fuse carried in said bulb adapted to pass electrical current between said first terminal and said second terminal unless said electrical current exceeds a predetermined level; and
a switch electrically in series between said first terminal and said fuse and adapted to pass said electrical current through said fuse when said filament fails.

9. The light as recited in claim 8, wherein said switch is a shunt.

10. A light for use with a string of lights, said light comprising:
a bulb;
a first terminal extending into said bulb from outside said bulb;
a second terminal extending into said bulb from outside said bulb;
a filament electrically connecting said first terminal to said second terminal;
a fuse carried in said bulb adapted to pass electrical current between said first terminal and said second terminal unless said electrical current exceeds a predetermined level; and
a switch electrically in series between said first terminal and second terminal and adapted to pass electrical current through said fuse when said filament fails.

11. The light as recited in claim 10, wherein said switch is a shunt.
